(19) United States
(12) Patent Application Publication
(10) Pub. No.: US 2003/0018617 A1
(43) Pub. Date: Jan. 23, 2003

(54) Information retrieval using enhanced document vectors

(76) Inventor: Holger Schwedes, Bruchsal (DE)

Correspondence Address: FISH & RICHARDSON, P.C., 500 ARGUELLO STREET, SUITE 500, REDWOOD CITY, CA, 64063-1526, US

(21) Appl. No.: 10/188,304

(22) Filed: Jul. 1, 2002

Related U.S. Application Data
(60) Provisional application No. 60/306,379, filed on Jul. 18, 2001.
(60) Provisional application No. 60/360,070, filed on Feb. 25, 2002.

(51) Int. Cl. G06F 7/00

(52) U.S. Cl. 707/2

(57) ABSTRACT

An information retrieval system includes an enhanced document vector module to generate enhanced document vectors representative of documents in a collection. The enhanced document vectors include text- and non-text components. The non-text components may include the location, in-links, and/or out-links in hypertext documents and attributes of the documents, e.g., size, create-date, and response-time. A processor uses the enhanced document vectors to perform an information retrieval operation, such as a clustering or classification operation.

### CROSS-REFERENCE TO RELATED APPLICATION

This application claims priority to U.S. Provisional Applications Serial No. 60/306,379, filed on Jul. 10, 2001, and Serial No. 60/360,070, filed on Feb. 25, 2002.

### BACKGROUND

Information retrieval (IR) is a discipline of computer science that deals with the retrieval of information from a collection of documents. IR systems attempt to retrieve documents that satisfy a user's information need, typically expressed in a query.

Powerful tools exist for searching and retrieving documents from large sources of documents. For example, some search engines are capable of sifting through gigabyte-size indexes of documents in a fraction of a second. However, search engines may retrieve a large collection of documents including a number that are irrelevant to the user query. Furthermore, the most relevant documents may be buried in the list of retrieved documents.

Document clustering is a technique used to organize large collections of retrieval results. A clustering algorithm groups together similar documents in order to facilitate a user's browsing of retrieval results.

### SUMMARY

An information retrieval system includes an enhanced document vector module to generate enhanced document vectors representative of documents in a collection. The enhanced document vectors may include text- and non-text components. The non-text components may include the location (e.g., a URL), in-links, and/or out-links in hypertext documents and attributes of the documents, e.g., size, create-date, and response-time. A processor uses the enhanced document vectors to perform an information retrieval operation, such as a clustering or classification operation.

The systems and techniques described here may result in one or more of the following advantages. The non-text components for the enhanced document vectors may provide information for determining the similarity between documents that text components may not supply, especially for documents containing many images but little text, which are compiled in different languages, or use synonyms and/or homonyms. The non-text components of the documents may be integrated transparently into the enhanced documents vectors, making the enhanced documents vector model compatible with clustering algorithms typically used with “text only” document vector models without modification.

### DRAWING DESCRIPTIONS

FIG. 1 is a block diagram of an information retrieval system.

FIG. 2 illustrates a number of document vectors.

FIG. 3 illustrates a number of weighted document vectors.

FIG. 4 illustrates a number of enhanced document vectors.

FIG. 5 illustrates a link pattern for the enhanced document vectors of FIG. 4.

FIG. 6 is a flowchart describing an information retrieval operation utilizing enhanced document vectors.

FIG. 7 shows a matrix defining an enhanced document vector space.

### DETAILED DESCRIPTION

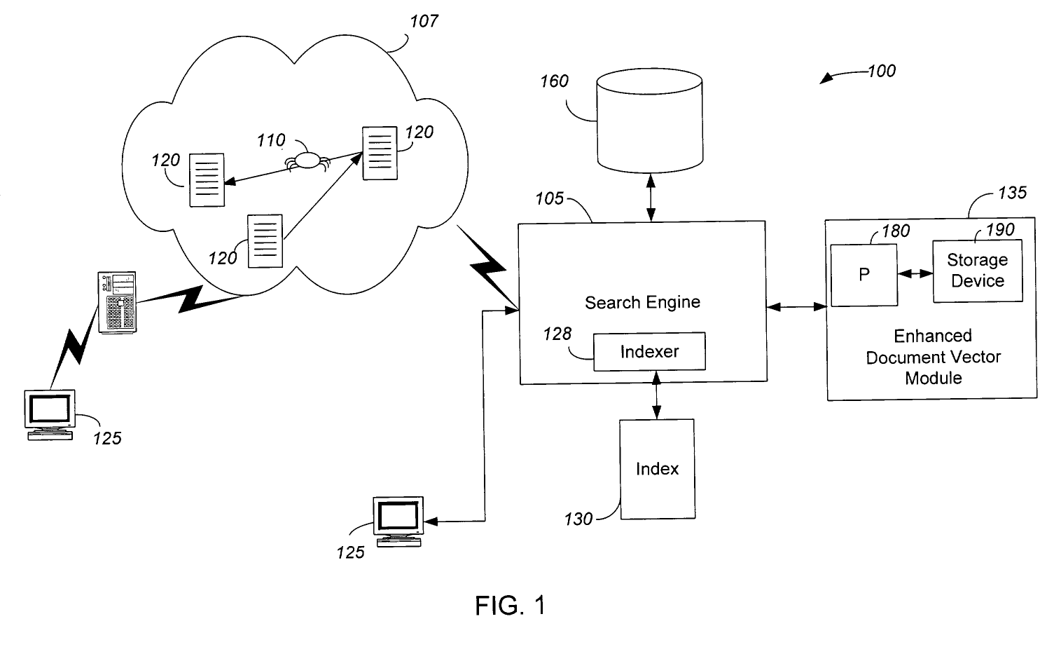

FIG. 1 illustrates an information retrieval (IR) system 100. The system 100 includes a search engine 105 to search a source 160 of documents, e.g., a server or database, for documents relevant to a user's query. An indexer 128 reads documents fetched by the search engine 105 and creates an index 130 based on the words contained in each document. The user can access the search engine 105 using a client computer 125 via, e.g., a direct connection or a network connection.

The user sends a query to the search engine 105 to initiate a search. A query is typically a string of words that characterizes the information that the user seeks. The query includes text in, or related to, the documents the user is trying to retrieve. The query may also contain logical operators, such as Boolean and proximity operators. The search engine 105 uses the query to search the documents in the source 160, or an index 130 of these documents, for documents responsive to the query.

Depending on the search criteria and number of documents in the source 160, the search engine 105 may return a very large collection of documents for a given search. An enhanced document vector module 135 can organize the retrieval results using a clustering algorithm together similar documents. The enhanced document vector module 139 may be, for example, a software program stored on a storage device 190 and run by the search engine 105 or by a programmable processor 180.

The enhanced document vector module 135 uses a document vector space model, in which documents are represented as a set of points in a multi-dimensional vector space. The enhanced document vector module 135 identifies terms in the documents in the collection and uses the terms to generate the vector space. Each dimension in the document vector space corresponds to a unique term (or text-component) in the document collection; the component of a document vector along a given direction corresponds to the importance of that term to the document. Similarity between two documents typically is measured by the cosine of the angle between their vectors, though Cartesian distance alternatively may be used. Documents judged to be similar by this measure are grouped together by the clustering algorithm used by the enhanced document vector module 135.

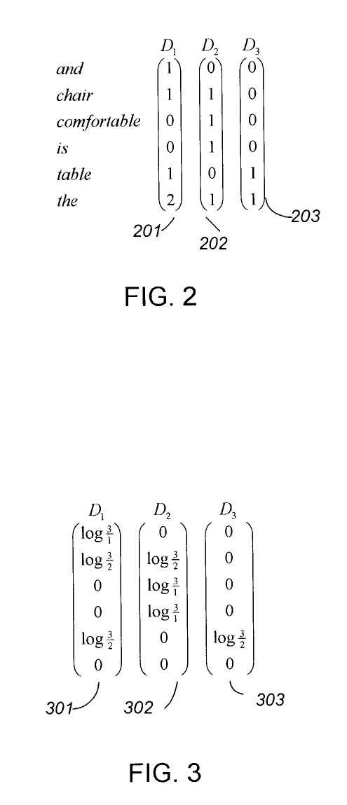

FIG. 2 illustrates document vector representations 201-203 for documents containing the following terms: “the table and the chair” (D1); “the chair is comfortable” (D2); and “the table” (D3). The degree of similarity for these documents may be represented by the cosine of the angle between the corresponding vectors.

$$s i m ( {D}_{x} , {D}_{y} ) = \frac{{\sum }_{i = 1}^{t} {x}_{i} \cdot {y}_{i}}{\sqrt{{\sum }_{i = 1}^{t} {x}_{i}^{2} \cdot {\sum }_{i = 1}^{t} {y}_{i}^{2}}}$$

The terms can be weighted to dampen the influence of trivial text. One type of weighting is TFIDF, which is a function of the text frequency (TF) and (IDF) inverse document frequency. The weight of a term can be expressed as follows:

$${w}_{ij} = {tf}_{ij} \cdot log \frac{N}{n} ,$$

,where

wᵢⱼ=weight of text Tⱼ in document Dᵢ,

tfᵢⱼ=frequency of text Tⱼ in document Dᵢ,

N=number of documents in collection, and

n=number of documents where text Tⱼ occurs at least once.

FIG. 3 illustrates the document vectors 301-303 of the exemplary documents weighted using a TFIDF weighting technique. Note that, as a result of the TFIDF weighting, the last entry of each vector, the trivial term “the”, is now “0” and is no longer a factor in the computation of the document similarities.

Electronic documents generally include non-text components in addition to text. For example, hypertext documents may have hyperlinks to or from other documents. Other non-text components of electronic documents may include document attributes, such as size, file type, creation date, and response-time (e.g., when retrieving documents from the Internet). This information may be contained in the documents themselves or as meta-data stored with the documents.

The document vector model employed by the enhanced document vector module 135 may be an enhanced document vector model in which non-text document components are included as dimensions in the vector space. In one implementation, the enhanced document vector model includes non-text components of hypertext documents. The search engine 105 can retrieve hypertext documents from the World Wide Web (the “Web”). The search engine 105 may use spiders 110, or Web robots, to build and periodically an index 130 of documents. The spiders 110 are programs that scan the World Wide Web 107 (the “Web”) looking for the URLs (Uniform Resource Locators) of Web “pages.”

Web pages 120 are hypertext documents on the Web, which are written in a markup language such as HTML (Hypertext Markup Language). The address of a Web page is identified by a URL. Web pages 120 are connected to other Web pages, as well as graphics, binary files, multimedia files, and other Internet resources, through hypertext links, or “hyperlinks.” The hyperlinks may include in-links (i.e., links into a document from other documents) and out-links (i,.e., links from the document out to other documents).

A spider 110 starts at a particular Web page 120, and then accesses all the links from that page. The indexer 128 reads the documents fetched by the spider 110 and creates the index 130 based on the words contained in each document. (See FIG. 1.)

The non-text components of the Web pages, e.g., hyperlinks and URLs, contain information that may be useful in clustering and classifying Web pages, especially for similar pages that contain many images but little text, are compiled in different languages, and/or include synonyms or homonyms. To utilize this information in IR, the hyperlink(s) and URL for each page can be charted into the enhanced document vector model along with text components.

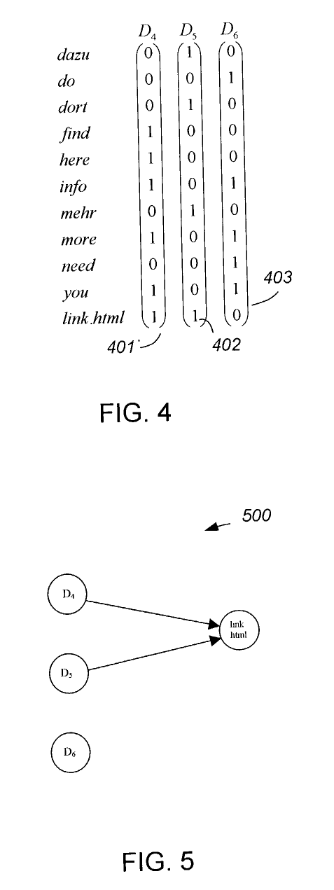

FIGS. 4 and 5 illustrate enhanced document vector representations 401-403 and the link pattern 500, respectively, for the following hypertext documents: “you find more info <a href=“link.html”>here</A>” (English document D4); “mehr dazu: <a href=“link.html”>dort<A/>” (German document D5); and “do you need more info?” (English document D6). Documents D4 and D5 are similar in content, but are expressed in different languages, i.e., English and German. However, in this example, the similarity between the documents D4 and D5 is more readily determined on the basis of the hyperlink to the same location “link.html” contained in each document than the text in the documents.

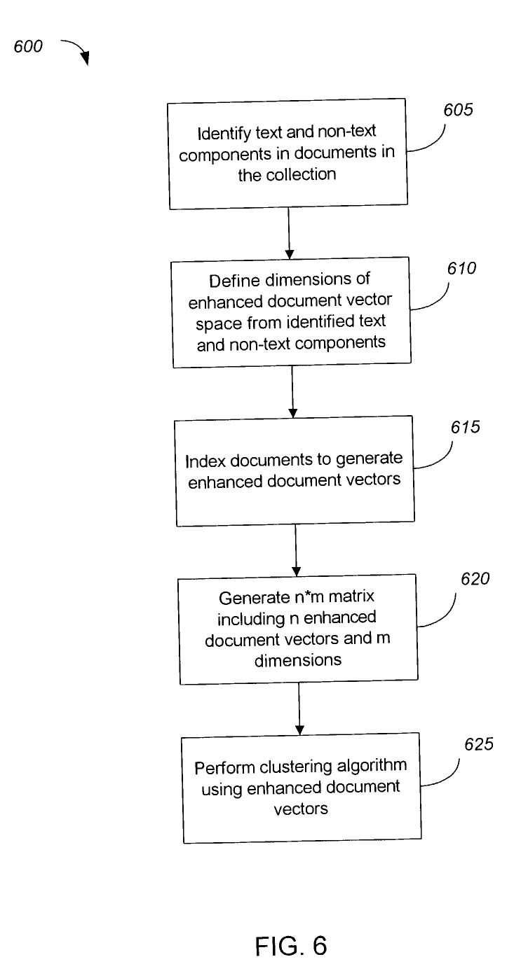

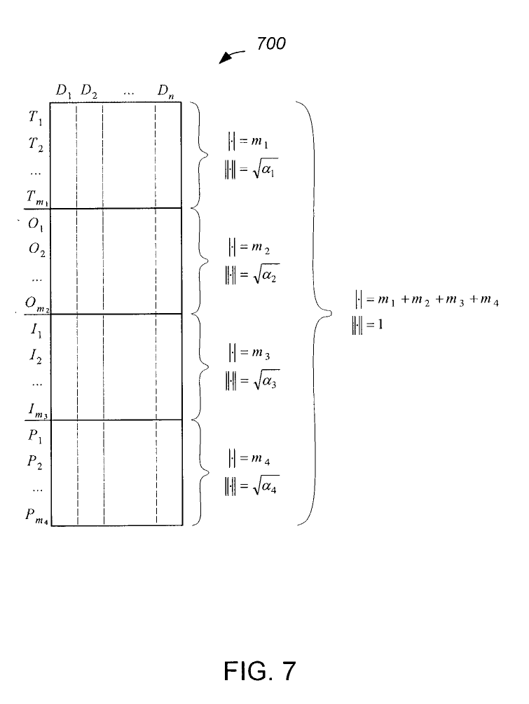

FIG. 6 shows a flowchart describing an IR operation 600 utilizing enhanced document vectors. A n*m-dimensional matrix 700 such as that shown in FIG. 7 is generated for documents and the text- and non-text components of the documents in a collection. The text- and non-text components (e.g., URLs and hyperlinks) of the documents are identified (block 605) and used to define the dimensions of the enhanced document vector space (block 610). The documents are indexed according to their text- and non-text components (block 615). The indexing operation identifies all of the text- and non-text components of the individual documents, resulting in enhanced document vectors D₁, . . . Dₙ. An n*m matrix is generated, where the n columns correspond to the enhanced document vectors and the m rows correspond to the dimensions of the enhanced document vector space (block 620). The enhanced document vector module 135 then performs an IR operation using the enhanced document vectors, for example, a clustering algorithm to cluster documents into different groups (block 625).

The enhanced document vectors can be partitioned according to type. For example, the enhanced document vectors shown in FIG. 7 are partitioned into text partial vectors (T₁ . . . Tₘ₁), out-link partial vectors (O₁ . . . Oₘ₂), in-link partial vectors (I₁ . . . Iₘ₃), and URL partial vectors (P1 . . . Pₘ₄). The number of dimensions (|.|) equals the sum of the partial dimensions m₁, m₂, m₃, and m₄. The sum of the norms (\sqrt{αᵢ}), or lengths, of the partial vectors equals the overall length (||.||) of the vector, which equals one (unity).

As described above, other non-text components of electronic documents may be included in the enhanced document vector model.

Some non-text components may be more useful than others. The degree of usefulness may change for different types of searches. The relative importance of the non-text components may be taken into account by weighting the different partial vectors differently. The different parts of the vectors can be weighted against each other by scaling the partial vectors as long as the total vector length equals unity. For example, the text and various non-text components can be weighted using TFIDF techniques.

The transparent integration of the additional document non-text components makes the enhanced document vector model compatible with clustering algorithms typically used with “text only” document vector models without modification. These clustering algorithms may include, for example, k-means, group-average, or star-clustering algorithms. The enhanced document vector model can also be used with other IR methods including, for example, classification and feature extraction.

In alternative embodiments, the dimensionality of the enhanced document vector space may be reduced, thereby reducing the complexity of the document representation and increasing the speed of computation. This may be done by keeping only the most important text- and non-text components from each document, as judged by a weighting scheme.

The operations can be performed by a programmable processor 180 executing instructions in a program. The instructions can be stored in storage device 190 including a machine-readable medium, such as optical and/or magnetic disk medium or solid state medium, such as a RAM (Random Access Memory) or ROM (Read Only Memory).

A number of embodiments have been described. Nevertheless, it will be understood that various modifications may be made without departing from the spirit and scope of the claims. For example, blocks in the flowchart may be skipped or performed in different order and still produce desirable results Accordingly, other embodiments are within the scope of the following claims.

1. A method comprising:
generating a plurality of document vectors for a corresponding plurality of documents, said document vectors including text components and non-text components; and
performing an information retrieval operation using the generated document vectors.

2. The method of claim 1, wherein performing the information retrieval operation comprises determining a similarity between two of the document vectors.

3. The method of claim 2, wherein determining a similarity comprises determining at least one of a distance and an angle between the two document vectors.

4. The method of claim 1, wherein performing the information retrieval operation comprises performing a clustering operation.

5. The method of claim 1, wherein performing the information retrieval operation comprises performing a classification operation.

6. The method of claim 1, wherein performing the information retrieval operation comprises performing a feature extraction operation.

7. The method of claim 1, further comprising:
identifying text components and non-text components in the plurality of documents; and
generating an enhanced document vector space including a plurality of dimensions corresponding to the text components and the non-text components.

8. The method of claim 7, wherein identifying non-text components of the plurality of documents comprises identifying at least one of a location, a link, a size, a create-date, and a response-time of one or more of the plurality of documents.

9. The method of claim 1, further comprising:
weighting one or more of the text and non-text components.

10. The method of claim 9, wherein weighting comprises performing a TFDIF weighting operation on the one or more of the text and non-text components.

11. Apparatus comprising:
a processor operative to generate a plurality of enhanced document vectors representative of a plurality of documents, at least one of the enhanced document vectors in said plurality including text components and non-text components.

12. The apparatus of claim 11, wherein the enhanced document vectors are representative of hypertext documents.

13. The apparatus of claim 12, wherein the non-text components include a location of the hypertext document.

14. The apparatus of claim 13, wherein the location comprises a URL (Uniform Resource Locator).

15. The apparatus of claim 12, wherein the non-text components include in-links.

16. The apparatus of claim 12, wherein the non-text components include out-links.

17. The apparatus of claim 11, wherein the non-text components include at least one of a size, a create-date, and a response-time of one or more of the plurality of documents.

18. The apparatus of claim 11, wherein the processor is further operative to perform an information retrieval operation utilizing the enhanced document vectors.

19. The apparatus of claim 18, wherein the information retrieval operation comprises determining at least one of an angle and a distance between two of the enhanced document vectors.

20. The apparatus of claim 18, wherein the information retrieval operation comprises determining a similarity between a plurality of said enhanced document vectors.

21. The apparatus of claim 18, wherein the information retrieval operation comprises a clustering operation.

22. The apparatus of claim 18, wherein the information retrieval operation comprises a classification operation.

23. The apparatus of claim 18, wherein the information retrieval operation comprises a feature extraction operation.

24. A system comprising:
a source of a first plurality of documents, documents in said first plurality including text components and non-text components;
an input device operative to receive a user query;
a search engine operative to retrieve a second plurality of documents from the first plurality of documents in response to the user query;
an enhanced document vector module operative to generate a plurality of enhanced document vectors representative of documents in the second plurality of documents, said enhanced document vectors including text components and non-text components; and
a processor operative to perform an information retrieval operation using said enhanced document vectors.

25. The system of claim 24, wherein the source of documents comprises one or more databases.

26. The system of claim 24, wherein the source of documents comprises one or more servers.

27. The system of claim 24, wherein the source of documents comprises a networked computer system.

28. The system of claim 24, wherein the documents comprise hypertext documents.

29. The system of claim 28, wherein the non-text components locations of the hypertext documents.

30. The system of claim 28, wherein the non-text components comprise hyperlinks.

31. The system of claim 24, wherein the non-text components comprise attributes of the documents.

32. The system of claim 24, wherein the information retrieval operation comprises a clustering operation.

33. The apparatus of claim 24, wherein the information retrieval operation comprises a classification operation.

34. The apparatus of claim 24, wherein the information retrieval operation comprises a feature extraction operation.

35. An article comprising a machine-readable medium including machine-executable instructions operative to cause a machine to:
generate a plurality of enhanced document vectors for a corresponding plurality of documents, said enhanced document vectors including text components and non-text components; and
perform an information retrieval operation using said enhanced document vectors.

36. The article of claim 35, wherein the instructions operative to cause the machine to perform the information retrieval operation comprises instructions operative to cause the machine to perform a clustering algorithm.
